(19) United States
(12) Patent Application Publication
(10) Pub. No.: US 2007/0288597 A1
(43) Pub. Date: Dec. 13, 2007

(54) Computer system and read-write medium therein

(75) Inventors: Sheng-Hsiung Chang, Taipei (TW); Chao-Chung Wu, Taipei (TW); Jiun-Liang Wu, Taipei (TW); Ya-Chin Chen, Taipei (TW)

Correspondence Address: BIRCH STEWART KOLASCH & BIRCH, PO BOX 747, FALLS CHURCH, VA, 22040-0747, US

(73) Assignee: ASUSTeK COPUTER INC.

(21) Appl. No.: 11/806,794

(22) Filed: Jun. 4, 2007

(30) Foreign Application Priority Data
Jun. 5, 2006 (TW) 95119920

(51) Int. Cl. G06F 15/16

(52) U.S. Cl. 709/217

(57) ABSTRACT

A computer system comprises a receiver and a read-write medium. The receiver is used to receive a remote control signal from a remote controller. The read-write medium is applied to the computer system, and an operating software is stored therein. The computer system can analyze the remote control signal via executing the operating software. The computer system can select and execute some application programs in the computer system or change hardware settings according to the remote control signal.

### BACKGROUND OF THE INVENTION

(1) Field of the Invention

The invention relates to a computer system, more particularly to a computer system controlled by remote control signals, wherein the remote control signals control the application programs and functions of the computer.

(2) Description of the Prior Art

With the advancement of the high technology, the data processing and operation abilities are powerful. Meanwhile, in order to meet the requirements of users, no matter the software or the hardware, each makes a mighty advance so as to broadly distribute the applications to computer.

Computer becomes a part of each person everyday, such as paper works, presentations, browsing and finding information on the Internet, using a multimedia program to play some music or films during leisure time, utilizing a communication software to make contact with friends or relatives, video/voice interaction, and so on. It is then that the computer brings us a convenient and great life.

Generally speaking, the user utilizes a mouse or a keyboard to control the application program and execute functions of the computer. However, according to some specific functions, such as turning on/off the computer, making the computer enter into a sleeping mode, a power saving mode, a low noise mode, and so on, the above functions need to proceed several actions via the mouse and keyboard, thereby to adjust the settings in the control center of an operating system, BIOS or hardware.

Moreover, a concept of digital home prevails over the world gradually. A computer with powerful functions is especially a main role at a home. The user can use different application programs of the computer to play music, video or net TV. Therefore, the computer at least integrates the functions of the audio, TV and video player. When the above multimedia programs are executed, the user has to utilize the mouse and keyboard to adjust the volume and change channels, etc. That is, to control the computer is not as friendly as to control a TV.

According to the disadvantages of the above prior art, the present invention utilizes the computer in coordination with related software and hardware to solve the inconveniences in prior arts.

### SUMMARY OF THE INVENTION

An objective of the present invention is to provide a computer system controlled by remote control signals. The user can define the keys of a remote controller corresponding to the control commands of application programs, and define different settings according to different application programs so as to meet personal habits of a user. As a result, it is very convenient to that the user remotely controls the application program during executing the application programs.

Another objective of the present invention is to utilize the remote controller to transmit a single remote control signal, and then the operating software will analyze the single remote control signal and make the computer be in some specific modes, such as sleeping mode, low noise mode, and so on. Thus, the computer system of the present invention can transform into specific modes via a one-click function without going through the mouse or the keyboard.

The computer system of the present invention comprises a receiver and a read-write medium. The receiver is used to receive a remote control signal from a remote controller. The read-write medium is applied to the computer system and has an operating software. The computer system can analyze the remote control signal via executing the operating software. The computer system can select and execute some application programs in the computer system or adjust hardware settings according to the remote control signal.

The present invention discloses a read-write medium applied to a computer system. The read-write medium comprises an operating software capable of analyzing a remote control signal received by the computer system. The computer system can select and execute some application programs in the computer system or adjust hardware settings according to the remote control signal.

These and the other objectives of the present invention will no doubt become obvious to those of ordinary skill in the art after reading the following detailed description of the preferred embodiment which is illustrated in the various figures and drawings.

### BRIEF DESCRIPTION OF THE DRAWINGS

The present invention will now be specified with reference to its preferred embodiment illustrated in the drawings, in which:

FIG. 1 illustrates a reference diagram of a computer system the present invention;

FIG. 2 illustrates a relationship diagram of components of the computer system of the present invention; and

FIG. 3 illustrates a flow sheet that the computer system is controlled by a remote control signal in the present invention.

### DESCRIPTION OF THE PREFERRED EMBODIMENT

The present invention provides a computer system, wherein remote control signals can drive some specific functions of the computer system to make a computer enter into some specific modes, and control some specific application programs. That is, the computer can be controlled by a remote controller without any mouse and keyboard.

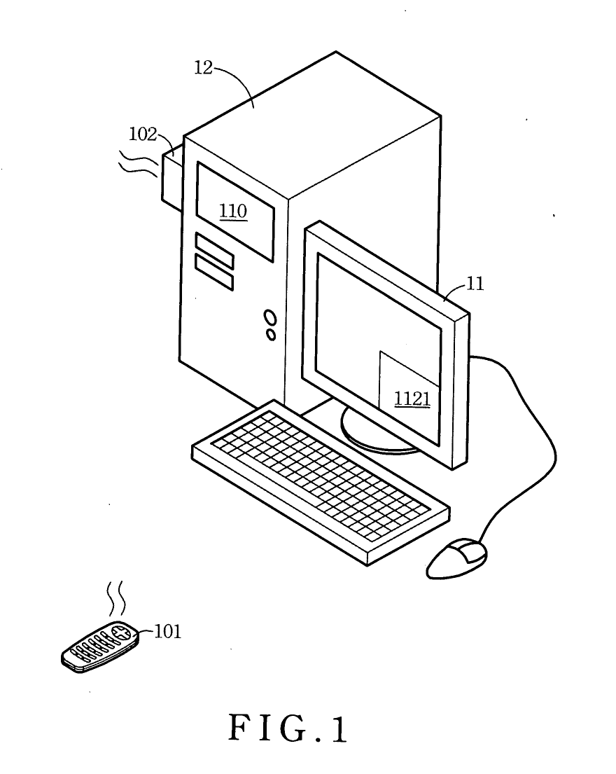

Please refer to FIG. 1, which illustrates a reference diagram of the computer system the present invention. The computer system comprises a computer monitor 11, a computer host 12, a remote controller 101, a receiver 102, and a read-write medium 110. Wherein, the read-write medium 110 has an operating software 112 therein, and the operating software 112 is a resident program. When the above operating software 112 is executed, an operating window 1121, showing an operating status, of the operating software 112 can be either shown or not shown on the computer monitor 11.

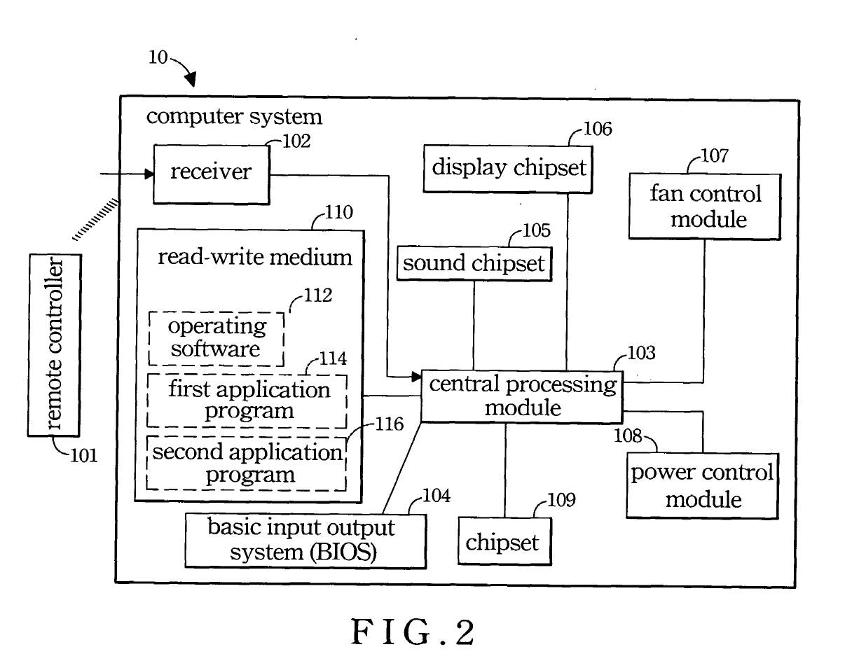

Please refer to FIG. 2, which illustrates a relationship diagram of components of the computer system 10 of the present invention. The receiver 102 is used to receive the remote control signals from the remote controller 101.

The read-write medium 110 is applied to the computer system 10. The operating software 112 is capable of analyzing the remote control signals from the receiver 102, so that the computer system 10 can choose and execute some specific application programs in the computer host 12 according to the remote control signals. Moreover, the computer system 10 can adjust hardware settings of the computer system 10, thereby to drive some specific functions of the computer system 10 to make computer system 10 enter into some specific modes.

That is, when the operating software 112 is executed, the remote control signal from the receiver 102 is transmitted to a central processing module 103 or a basic input output system (BIOS) 104. Wherein, the central processing module 103 includes a CPU, a south bridge chipset, and a north bridge chipset. And then, the computer system 10 will proceed corresponding procedures via the central processing module 103 or the basic input output system (BIOS) 104, wherein the corresponding procedures are in accordance with a fan control module 107, a power control module 108, a display chipset 106, a sound chipset 105, and the other chipset 109. For example, the hardware settings are adjusted or related drivers are executed via the basic input output system (BIOS) 104, thereby to adjust the hardware efficiency of the computer system 10 and make the computer system 10 enter into some specific modes.

One feature of the present invention is to utilize keys of the remote controller 101 to transmit different remote control signals to the receiver 102. In the embodiment, one remote control signal is a power on/off signal for turning on or turning off the computer system 10. Further that, the operating software is capable of analyzing the power on/off signal and makes the computer system 10 enter into a sleeping mode, power saving mode or turning off mode according to the power on/off signal.

While the computer system 10 is in a power off state and receives the power on/off signal from the remote controller 101, the chipset 109 of the computer system 10 will turn on the computer system 10 according to the power on/off signal.

While the computer system 10 is in a power on state and receives the power on/off signal, the computer system 10 can analyze the power on/off signal by way of executing the operating software 112. And then, the computer system 10 can optionally go into the sleeping mode of S4 (Suspend to disk) or the turning off of S5 (Shutdown) based on the signals.

Wherein, the sleeping mode of S4 (Suspend to disk) means that the data in the memory of the operating system are stored in the hard disk. The computer system 10 can directly read the data from the hard disk while the computer system 10 is turned on next time. As a result, the computer system 10 is accelerated in the aspect of booting speed without going through a normal booting procedures.

When the operating software 112 identifies that the remote control signal is a quickly turning off signal (Quick Power), the computer system 10 then enters into a standby mode (Suspend to RAM) from the normal mode.

The above standby mode means said S3 (Suspend to RAM) state. When the computer system 10 enters into the S3 state, the operating system keeps the data existed in the RAM, and then the computer system 10 enters into the state of “pretend close down”. At this time, only the RAM needs power to keep the data, but other devices are not. That is, only the power light is on, others are turned off. As long as the computer system 10 is booted again and the computer system 10 confirms the completeness of the data in the RAM, the computer system 10 will return to the state which is before the S3 state, thereby to accelerate the booting speed. It is noted that, the application of the present invention is not limited in the S3 or S4 state under the Microsoft Window OS. The present invention can use different sleep control methods according to different operating systems, such as Linux operating system, etc.

When the operating software 112 identifies that the remote control signal is a noise off signal, the computer system 10 adjusts the efficiencies of the central processing module 103, an optical disk drive, and the fan control module 107 to reduce noise and enter into a low noise mode.

Generally speaking, the related hardware components of the computer system 10 are not operated in higher operating frequencies all the time if the computer system 10 is under a low resource usage condition. Meanwhile, the user can transmit the noise off signal via the remote controller 101, and then make the computer system 10 enter into the low noise mode. The computer system 10 can execute the operating software 112 automatically to cancel the low noise mode while the computer system 10 returns to a high resource usage condition. Wherein, the low noise mode can be canceled automatically or by the user.

When the operating software 112 identifies that the remote control signal is a wireless dedicated signal(EZ WiFi), the computer system 10 adjusts the efficiencies of the central processing module 103, the CD-ROM drive, the hard disk drive, and the fan control module 107 to stop the operations of the display chipset 104 and sound chipset 105, thereby to close down the screen and the sound of the computer system 10. And then, the computer system 10 enters into the power saving and low noise mode, and only provides wireless function. However, a network phone, such as skype phone, disposed in the computer system 10 can be operated normally. Besides, if the motherboard of the computer system 10 has a wireless LAN AP, other computer still can access to the Internet via the computer system 10.

As aforesaid, a conventional computer must use a mouse or a keyboard to execute some operations, thereby to enter one of the above specific modes. However, the user just utilizes the remote controller 101 to transmit a remote control signal via an one-click key in the present invention. And then, the operating software 112 analyzes the remote control signal and transmits a command to the operating system or BIOS so as to make the computer system 10 enter into on of the specific modes. Consequently, the computer system 10 of the present invention is very convenient for the user.

As the above mentioned, the computer system 10 of the present invention is capable of analyzing the remote control signal by executing the operating software 112. Therefore, the computer system 10 can select and execute the application programs, which are already existed in the computer system 10 according to the remote control signal.

That is, the remote control signal is transformed to a control command, which can control the application program, via the operating software 112. So that the key of the remote controller 101 becomes an access key that can control the application program. Therefore, the user can utilize the remote controller 101 to transmit the remote control signal to control the application program during the computer system 10 executes the application program.

Besides, the remote control signal also can make the operating software 112 to select and execute different application programs. As shown in FIG. 2, the user can select the first application program 114, the second application program 116 or other application programs.

When the operating software 112 is executed, a first menu is called via the remote control signal so as to provide corresponding application programs to the user. When the needed application program is selected by the user, a second menu is then shown so as to set keys of the remote controller 101 corresponding to the control commands of the application program, so that the application program can be controlled via the remote controller 101.

The operating software 112 is allowable to let the user define a control command in the application program. Wherein, the control command corresponds to the remote control signal from the remote controller 101. Therefore, when the computer system receives the remote control signal, the computer system 10 will transmit the control command according to the remote control signal, thereby to control the application program.

In one embodiment, the application program is a multimedia program. The control command is selected from the group of full-screen command, volume control command, play/stop command, previous/next paragraph command, and menu command. That is, the remote control signal is corresponding to the control command of the multimedia program while the multimedia program is executed.

When the user utilizes the computer system 10 to execute the multimedia program to watch movie or listen to music, the user can press the keys of the remote controller 101 to transmit the remote control signals to the computer system 10. And then, the operating software 112 transmits the control commands to the multimedia program according to the remote control signals, thereby to control some functions, such as volume adjusting, paragraph changing, full-screen displaying, etc.

In another embodiment, the application program is a presentation program. The control command is selected from the group of full-screen command, volume control command, play/stop command, previous page/next page command, and menu command. If the application program is the PowerPoint®, the user can utilize the remote controller 101 to control some functions, such as page changing, full-screen displaying, etc. Thus, the present invention is very convenient to business people. It is noted that, one feature of the present invention is to utilize the keys of the remote controller to control some specific application programs, such as multimedia program, presentation program, etc.

Besides, other application programs can be added to the menu of the operating software by the user. Hence, there are more application programs can be chosen while the operating software is executed.

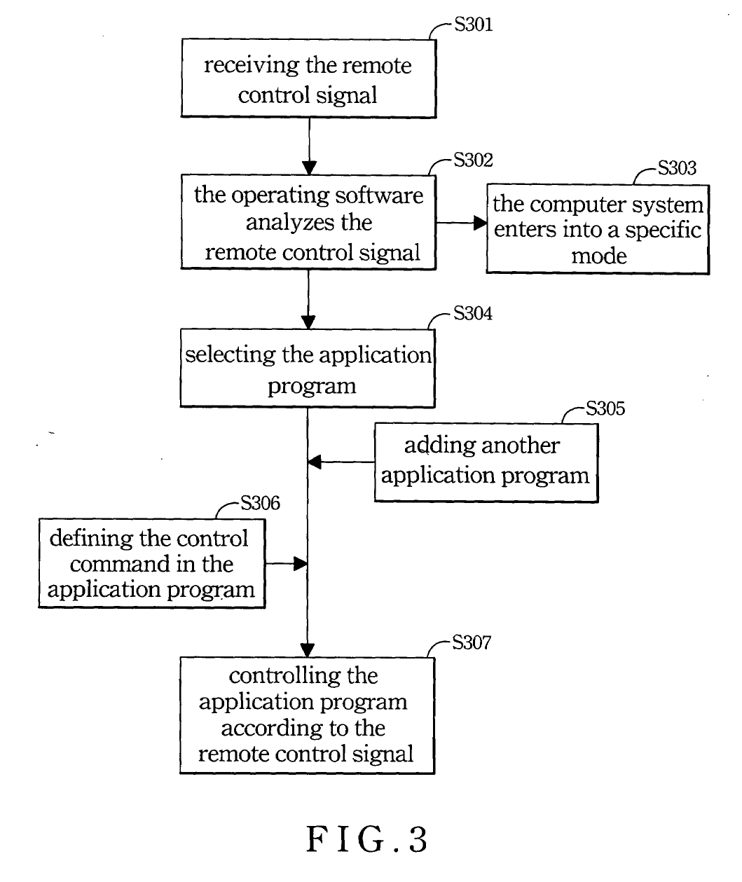

Please refer to FIG. 3, which illustrates a flow sheet that the computer system 10 is controlled by the remote control signal in the present invention. The computer system 10 utilizes the receiver 102 to receive the remote control signal from the remote controller 101 (S301). The operating software 112 analyzes the remote control signal (S302). If the operating software 112 identifies that the remote control signal is a specific signal, the operating software 112 will make the computer system 10 enter into a specific mode (S303), such as the sleeping mode, low noise mode, and so on. Furthermore, according to the difference of control commands defined by the remote control signals, the operating software 112 can execute the following steps of: selecting the application program that the user wants to execute (S304); utilizing the remote control signal to add another application program (S305); defining the control command in the application program (S306); controlling the application program according to the remote control signal (S307).

Therefore, when the computer system 10 executes the operating software 112, the computer system 10 proceed two operating modes according to the remote control signal. One operating mode is to make the computer system 10 enter into some specific states, the other is to control the application programs executed by the computer system 10.

Wherein, the user can choose one of the application programs to execute (S304), add another application program (S305), define the control command in the application program (S306), or directly control the application program via the remote control signal. However, the above three steps, S304, S305, and 306, can be proceeded selectively according to actual requirements.

As stated above, the present invention has several advantages. First, utilizing the remote controller to transmit a single remote control signal, and then the operating software will analyze the single remote control signal and make the computer enter some specific modes, such as sleeping mode, low noise mode, and so on. Thus, the computer system of the present invention has several specific modes via the function of one-click, and dose not need to use the mouse or the keyboard to execute several options.

Secondly, the user can utilize the remote controller to open the application program, select files of the application program, and control the application program without using the mouse and the keyboard.

Thirdly, the user can define keys of the remote controller corresponding to the control commands of the application program, and define different settings according to different application programs so as to meet personal habits of the user. As a result, it is very convenient to the user to remotely control the application program during executing the application program.

With the example and explanations above, the features and spirits of the invention are hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A read-write medium applied to a computer system, comprising: an operating software being capable of analyzing at least one remote control signal received by said computer system and executing a specific application program or adjusting hardware settings of said computer system according to said remote control signal.

2. The read-write medium of claim 1, when said specific application program is executed, said operating software is allowable to let a user define a control command in said application program.

3. The read-write medium of claim 2, wherein said application program is a multimedia program, said control command is selected from the group of full-screen command, volume control command, play/stop command, previous/next paragraph command, and menu command.

4. The read-write medium of claim 2, wherein said application program is a presentation program, said control command is selected from the group of: full-screen command, volume control command, play/stop command, previous page/next page command, and menu command.

5. The read-write medium of claim 1, wherein other application programs can be added and chosen when said operating software is executed.

6. The read-write medium of claim 1, wherein said operating software transmits a command to a basic input output system (BIOS) according to said remote control signal, thereby to adjust said hardware settings of said computer system via said BIOS.

7. The read-write medium of claim 1, wherein said remote control signal is a power on/off signal for turning on/off said computer system.

8. The read-write medium of claim 1, wherein said operating software can make said computer system enter into a mode, which is selected from the group of: sleeping mode, power saving mode, and turning off.

9. The read-write medium of claim 1, wherein said computer system enters into a standby mode (Suspend to RAM) when said operating software identifies that said remote control signal is a quickly turning off signal (Quick Power).

10. The read-write medium of claim 1, wherein said computer system adjusts the efficiency of a central processing module, an optical disk drive, and a fan of said computer system to reduce noise when said operating software identifies that said remote control signal is a noise off signal.

11. The read-write medium of claim 1, wherein said computer system adjusts the efficiency of a central processing module, an optical disk drive, a hard disk drive and a fan of said computer system and closes down a screen and sound thereof when said operating software identifies that said remote control signal is a wireless dedicated signal.

12. A computer system comprising:
a receiver being used to receive at least one remote control signal from a remote controller; and
a read-write medium having an operating software, wherein said operating software is capable of analyzing said remote control signal from said receiver, and executing a specific application program or adjusting hardware settings of said computer system according to said remote control signal.

13. The computer system of claim 12, when said specific application program is executed, said operating software is allowable to let a user define a control command in said application program.

14. The computer system of claim 13, wherein said application program is a multimedia program, said control command is selected from the group of full-screen command, volume control command, play/stop command, previous/next paragraph command, and menu command.

15. The computer system of claim 13, wherein said application program is a presentation program, said control command is selected from the group of: full-screen command, volume control command, play/stop command, previous page/next page command, and menu command.

16. The computer system of claim 13, when said application program is executed, a first menu is shown to provide an application program to be executed.

17. The computer system of claim 16, when said application program is executed, a second menu is shown so as to set keys of said remote controller corresponding to said control commands of said application program, so that said application program can be controlled via said remote controller.

18. The computer system of claim 12, wherein other application programs can be added and chosen when said operating software is executed.

19. The computer system of claim 12, wherein said operating software transmits a command to a basic input output system (BIOS) according to said remote control signal, thereby to adjust said hardware settings of said computer system via the BIOS.

20. The computer system of claim 12, wherein said computer system adjusts the efficiency of a central processing module, an optical disk drive, a hard disk drive and a fan of said computer system and closes down a screen and sound thereof when said operating software identifies that said remote control signal is a wireless dedicated signal.
